(19) United States
(12) Patent Application Publication
(10) Pub. No.: US 2003/0115197 A1
(43) Pub. Date: Jun. 19, 2003

(54) SNMP to CIM data mapper

(76) Inventors: Jeffrey A. Horan, Westboro, MA (US); Dana J. Porter, Westford, MA (US); Stephen P. McCarthy, Methuen, MA (US); David W. Tahajian, Belmont, MA (US)

Correspondence Address: BROMBERG & SUNSTEIN LLP, 125 SUMMER STREET, BOSTON, MA, 02110-1618, US

(21) Appl. No.: 10/017,439

(22) Filed: Dec. 14, 2001

(51) Int. Cl. G06F 7/00

(52) U.S. Cl. 707/6

(57) ABSTRACT

A method for accessing CIM-formatted management information from an CIM object manager using techniques for managing SNMP-formatted management information

### TECHNICAL FIELD AND BACKGROUND ART

The present invention relates to methods for accessing management information on computer systems.

Simple Network Management Protocol (“SNMP”) is an industry standard that models network devices in an enterprise-computing environment. SNMP is a mature standard—many systems currently collect SNMP-formatted management data. An SNMP client can request SNMP data from an SNMP agent running on a system and the agent will retrieve the SNMP data and returns it to the SNMP client. Likewise, an SNMP client can request that certain variables for management data be set on the system and the SNMP agent will change these variables accordingly. SNMP is specified in RFCs 1155 and 2578, published by the Internet Society International Secretariat, 1775 Wiehle Ave., Suite 102, Reston, Va. 20190, which are incorporated herein by reference.

The data that can be retrieved or set by an SNMP agent is described in a Management Information Base (“MIB”) file or files. Each SNMP data item is associated with a unique numeric string called an Object Identifier (“OID”) which is described in the MIB together with the type of the data item.

Common Information Model (“CIM”) is a more recent standard that models all elements in an enterprise-computing environment. CIM allows a client to manage those elements, i.e., not just networking elements. A client can request management information data to be retrieved from or set by a CIM object manager running on a system. CIM is specified in CIM Specification v 2.2, published by the Distributed Management Task Force, 200 SW Market Street, Suite 450, Portland, Oreg. 97201, which is incorporated herein by reference.

CIM data that can be retrieved or set is described in a Managed Object Format (“MOF”) file(s). These MOF files define CIM classes, which are containers for related information, e.g., a system class would be a container of system information. A CIM class comprises CIM properties, which are attributes associated with a CIM class, e.g., one piece of information such as “system name” in the system class.

Current SNMP protocols do not allow an SNMP client to access management information that is accessible only to CIM object managers, running either locally or on remote systems.

### SUMMARY OF THE INVENTION

In an embodiment of the present invention, an SNMP client requests access to management information, that is maintained by a CIM object manager (“CIMOM”). The request is received by the system running the CIMOM process and the requested data items are mapped from SNMP formats to an associated CIM object using a mapping file. The appropriate CIM objects are then accessed by CIMOM and CIM object properties are either retrieved or set. The CIM object properties are then mapped to SNMP variables using the mapping file and an SNMP response message is prepared. The response message is then sent to the SNMP client. This embodiment of the invention advantageously provides access to SNMP-formatted management information on a system that has implemented CIM protocols.

In another embodiment of the present invention, an SNMP client requests information according to Management Information Base (“MIB”) files that identify data items that can be retrieved or set by the SNMP client. Each data item in a MIB file(s) is transformed into a table entry in a mapping file containing a CIM class name and property name. These mapping files can then be used to translate SNMP data access requests to CIM data access requests.

### BRIEF DESCRIPTION OF THE DRAWINGS

The foregoing features of the invention will be more readily understood by reference to the following detailed description, taken with reference to the accompanying drawings, in which:

FIG. 1 is a block diagram for a portion of an enterprise computing system according to an embodiment of the invention; and

FIG. 2 is a flow chart illustrating a method of accessing CIM data by an SNMP client according to an embodiment of the invention.

### DETAILED DESCRIPTION OF SPECIFIC EMBODIMENTS

In an embodiment of the present invention, a MIB file is presented that specifies data that can be requested from or set by an SNMP agent running on a system, in response to an SNMP message. The MIB file is transformed into a mapping file that specifies the CIM classes and properties that correspond to the MIB file entries by a mib-to-map process. This transformation may be effected as follows:

1. A mapping file is generated for each MIB input file. The mapping file comprises entries that, for each OID in the MIB, include the OID, the corresponding CIM class name, a property name, a SNMP datatype for the variable, the next SNMP OID, and index count, and corresponding index pairs (property name and datatype).

2. A customization file may be provided. The file contains a series of entries that describe the correspondence between a SNMP group name and a CIM class name. It also specifies the next OID for the last OID in the group (or 0.0, if none).

3. For each SNMP variable in the MIB file, if no customization entry corresponds to the SNMP group, an entry in a mapping file is generated that includes the OID of the variable, a default CIM classname, a CIM property name matching the SNMP variable name, the SNMP datatype, a next OID value of the current OID plus one (or 0.0 if the last in the group), an index count and optional pairs of ordered index information (CIM property name and SNMP datatype). If customization values are provided, the default class name and next OID value are replaced by the corresponding values in a customization entry.

TABLE 1
SNMP to CIM Data Type Mapping

| SNMP Datatype | CIM Datatype |
|---|---|
| Integer | Sint32 (or equivalent) |
| Octet String | String (or equivalent) |
| Object Identifier | String |
| IpAddress | String |
| Counter | Uint32 (or equivalent) |
| Gauge | Uint32 (or equivalent) |
| Timeticks | Uint64 |
| Opaque | Sint8[] |

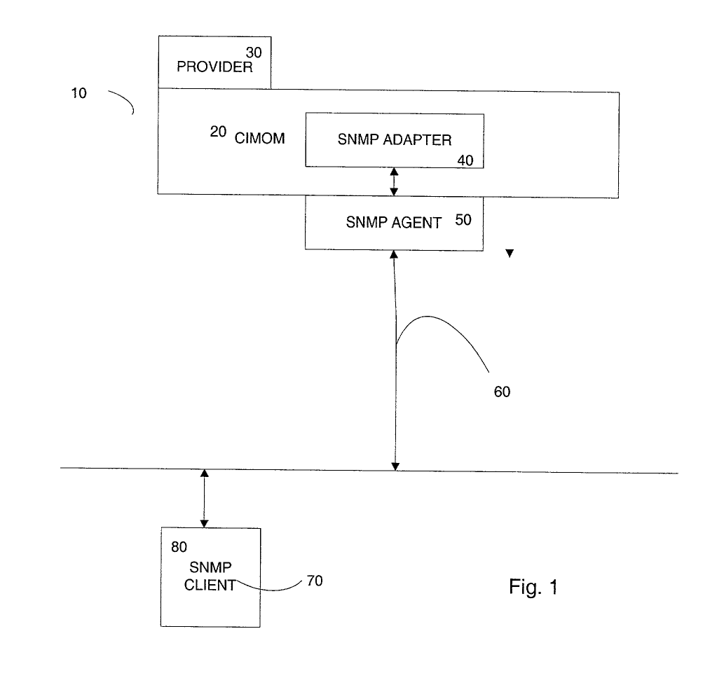

FIG. 1 is a block diagram of elements in an enterprise computing system according to another embodiment of the present invention. A computing system 10 executes a CIMOM process 20. CIMOM 20 accesses CIM data via a provider process 30. CIMOM 20 receives requests for CIM management information from an SNMP adapter process 40. The SNMP adapter process 40 receives requests for management information from an SNMP agent 50. The agent 50 communicates with an SNMP client process 70, running on a remote system 80 over a network 60. The SNMP client 70 may also be local to system 10.

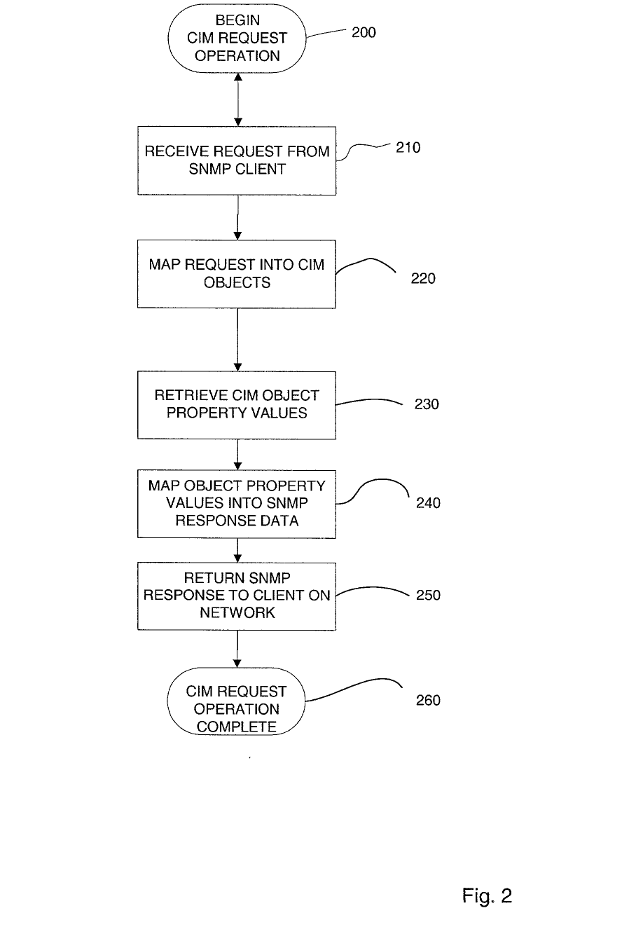

FIG. 2 is a flow diagram showing a method for an SNMP client application to access CIM information from a CIMOM process using SNMP protocols, according to an embodiment of the present invention. First, an SNMP agent 50 receives 210 an SNMP data access request from an SNMP client process 70, identifying management data to be accessed on the computing system 10. Next, an SNMP adapter 40 receives the request from the agent and maps 220 each of the data variables into a corresponding CIM property. This mapping may occur, for example, by reading entries prestored in a mapping file. In a specific embodiment of the invention, as described above for the mib-to-map process, each file entry includes an OID, CIM class name, CIM property name, SNMP datatype and next OID for each data item that can be accessed. The file entry may also contain SNMP table index information. The SNMP adapter forms a CIM object request, to either retrieve or set these CIM properties. The correspondence between SNMP datatypes and CIM datatypes is as shown in table 1. For certain of the entries as shown, an SNMP datatype may map into a specific CIM datatype or its equivalents. CIMOM responds to the request by accessing the object property through the appropriate provider. The SNMP adapter receives 230 a response from CIMOM, indicating the value of the property or that the property has been set and then maps 240 the property values into corresponding SNMP values and datatypes using mapping file information. The SNMP agent then completes the request 250 by preparing and returning an SNMP response message to the SNMP client.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

The present invention may be embodied in other specific forms without departing from the true scope of the invention. The described embodiments are to be considered in all respects only as illustrative and not restrictive.

What is claimed is:

1) A method for accessing management information using SNMP-formats, the information stored in CIM formats, the method comprising:
receiving a request message from an SNMP client;
mapping the request message into CIM formats; and
performing at least one of retrieving and setting a CIM object value.

2) A method according to claim 1, the method further comprising:
encoding CIM property values into SNMP formats; and
returning an SNMP response message to the SNMP client.

3) A method for generating a mapping file from a MIB file, the MIB file including at least one SNMP variable, the method comprising:
reading at least one SNMP variable from the MIB file; and
generating a mapping file entry for at least one of a group and a row sequence specified in the MIB file, the mapping file entry including an OID, a class name, a property name, a SNMP datatype and a next OID.

4) A method according to claim 3, wherein the mapping file entry further includes SNMP table indexes.

5) A computer program product for use on a computer system for accessing management information using SNMP-formats, the information stored in CIM formats, the computer program product comprising a computer usable medium having computer readable program code thereon, the computer readable program code including program code for:
receiving a request message from an SNMP client;
mapping the request message into CIM formats; and
performing at least one of retrieving and setting a CIM object value.
A computer program product for generating a mapping file from a MIB file, the MIB file including at least one SNMP variable, the computer program product comprising a computer usable medium having computer readable program code thereon, the computer readable program code including program code for:
reading at least one SNMP variable from the MIB file; and
generating a mapping file entry for at least one of a group and a row sequence specified in the MIB file, the mapping file entry including an OID, a class name, a property name, a SNMP datatype and a next OID.

6) A computer system for accessing management information using SNMP-formats, the information stored in CIM formats, the computer system comprising:
a buffer for receiving a request message;
logic that receives a request message from an SNMP client;
logic that maps the request message into CIM formats; and
logic that performs at least one of retrieving and setting a CIM object value.
